(19) United States
(12) Patent Application Publication
(10) Pub. No.: US 2003/0209619 A1
(43) Pub. Date: Nov. 13, 2003

(54) Spinning type fishing reel with a swing rod

(76) Inventor: Eugene Hong, Taichung City (TW)

Correspondence Address: MERCHANT & GOULD PC, P.O. BOX 2903, MINNEAPOLIS, MN, 55402-0903, US

(21) Appl. No.: 10/140,132

(22) Filed: May 7, 2002

(51) Int. Cl. A01K 89/01

(52) U.S. Cl. 242/241

(57) ABSTRACT

A spinning type fishing reel includes a rotating member disposed rotatably within a reel body, a sliding member disposed movably within the body and connected fixedly to a reciprocating shaft, and a swing rod interconnecting the rotating member and the sliding member. When a handle is actuated to rotate the rotating member, the swing rod swings to reciprocate the sliding member and the reciprocating shaft. Accordingly, when a fishline is wound on the spool, the number of the turns of the fishline wound during a forward travel of the reciprocating shaft is different from that wound during a reverse travel of the reciprocating shaft, thereby resulting in a quite even distribution of the fishline on the spool.

### BACKGROUND OF THE INVENTION

1. Field of the Invention

This invention relates to a spinning type fishing reel, and more particularly to a fishing reel, which includes a swing rod that is used to drive a reciprocating shaft so that the number of the turns of a fishline wound on a spool during each forward travel of the reciprocating shaft is different from that wound during each reverse travel of the reciprocating shaft, thereby resulting in a quite even distribution of the fishline on the spool.

2. Description of the Related Art

Referring to FIGS. 1 and 2, a conventional spinning type fishing reel is shown to include a body 1, a rotating member 2, a reciprocating shaft 3, a sliding member 4, a handle 5, a spool 6, a bail unit 7, and a rotating unit 8. The body 1 is hollow, and is formed with a shoulder 101. The rotating member 2 is configured as a spur gear, which has an integral eccentric post 201 and which is rotatable about a first axis 202 within the body 1. The reciprocating shaft 3 is disposed movably within the body 1, and is movable along a second axis 301 that is perpendicular to the first axis 202. The sliding member 4 is connected fixedly to an end of the reciprocating shaft 3, and is movable on the shoulder 101 of the body 1. The post 201 of the rotating member 2 is received movably within a straight slot 401 in the sliding member 4. The handle 5 has an integral gear 502 that meshes with the rotating member 2 so as to transfer rotation of the handle 5 to the rotating member 2. When the handle 5 and the rotating member 2 rotate, the post 201 moves within the body 1 along a circular path so as to reciprocate the reciprocating shaft 3 along the second axis 301, and the rotating unit 8 and the bail unit 7 rotate about the second axis 301. As such, a fishline (not shown) can be wound around or unwound from the spool 6. The aforesaid conventional fishing reel suffers from the following disadvantages:

(1) When the fishline is wound on the spool 6, it is shaped as a tubular unit, and is formed with a plurality of turns. The reciprocating shaft 3 effects a forward travel and a reverse travel during each revolution of the rotating member 2. The number of the turns formed during each forward travel of the reciprocating shaft 3 is equal to that formed during each reverse travel of the reciprocating shaft 3. In addition, the number of the turns formed at two end portions of the spool 6 is greater than that formed at a middle portion of the spool 6, thereby resulting in an uneven distribution of the fishline on the spool 6. Such an uneven fishline distribution will affect adversely smooth winding and unwinding operation of the fishing reel.

(2) The reciprocating shaft 3 moves between two end positions, which are spaced apart from each other by a distance that is twice the distance between the post 201 of the rotating member 2 and the first axis 202. Because the changeable range of the distance between the post 201 and the first axis 202 is relatively small due to volume constraint of the body 1, the changeable range of the distance between the end positions is reduced, thereby affecting utility of the fishing reel.

### SUMMARY OF THE INVENTION

An object of this invention is to provide a spinning type fishing reel, in which a fishline is wound on a spool so that the number of the turns of the fishline formed during each forward travel of a reciprocating shaft is different from that formed during each reverse travel of the reciprocating shaft, thereby resulting in a quite even distribution of the fishline on the spool. Another object of this invention is to provide a spinning type fishing reel, in which the moving distance of a reciprocating shaft during each of forward and reverse travels can be changed within a relatively large range. According to this invention, a spinning type fishing reel includes a rotating member disposed rotatably within a reel body, a sliding member disposed movably within the body and connected fixedly to a reciprocating shaft, and a swing rod interconnecting the rotating member and the sliding member. When a handle is actuated to rotate the rotating member, the swing rod swings to reciprocate the sliding member and the reciprocating shaft. Accordingly, when a fishline is wound on the spool, the number of the turns of the fishline wound during each forward travel of the reciprocating shaft is different from that wound during each reverse travel of the reciprocating shaft, thereby resulting in a quite even distribution of the fishline on the spool.

Preferably, the swing rod is connected rotatably to the body by a pivot element, and has a pair of first and second engaging portions, each of which extends in a radial direction. The first and second engaging portions are angularly spaced apart from each other, and engage respectively an engaging portion of the rotating member and an engaging portion of the sliding member. The reciprocating shaft is movable between two end positions during each of the forward and reverse travels. The distance between the end positions can be changed by varying either the distance between the engaging portion of the rotating member and the rotating axis of the rotating member or the position of the second engaging portion of the swing rod relative to the pivot element. As such, the changeable range of the distance between the end positions is increased.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a partly sectional view of a conventional spinning type fishing reel;

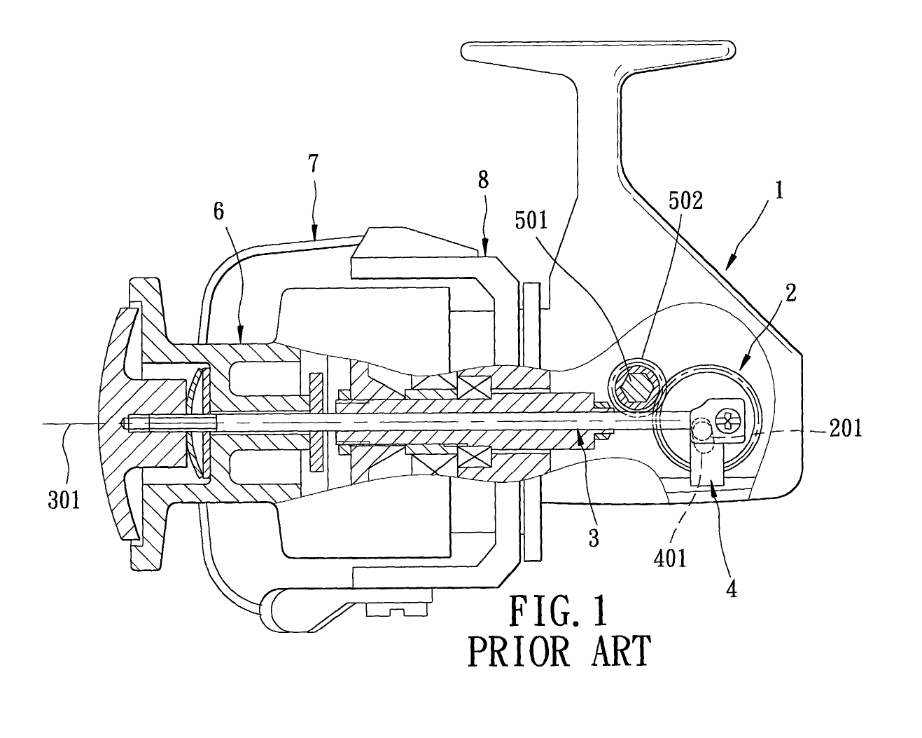

FIG. 2 is a fragmentary, partly sectional view of the conventional spinning type fishing reel;

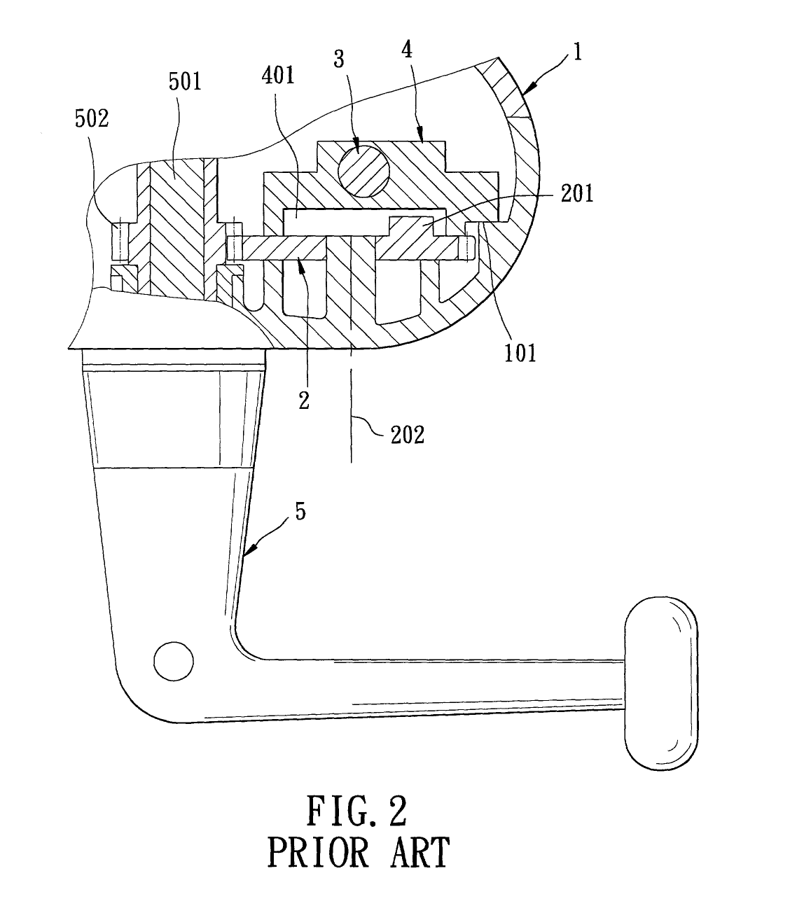

FIG. 3 is a partly sectional view of the preferred embodiment of a spinning type fishing reel according to this invention;

FIG. 4 is a fragmentary, partly sectional view of the preferred embodiment; and

FIG. 5 is a schematic view illustrating the rotational angles of a rotating member during forward and reverse travels of a reciprocating shaft of the preferred embodiment.

### DETAILED DESCRIPTION OF THE PREFERRED EMBODIMENT

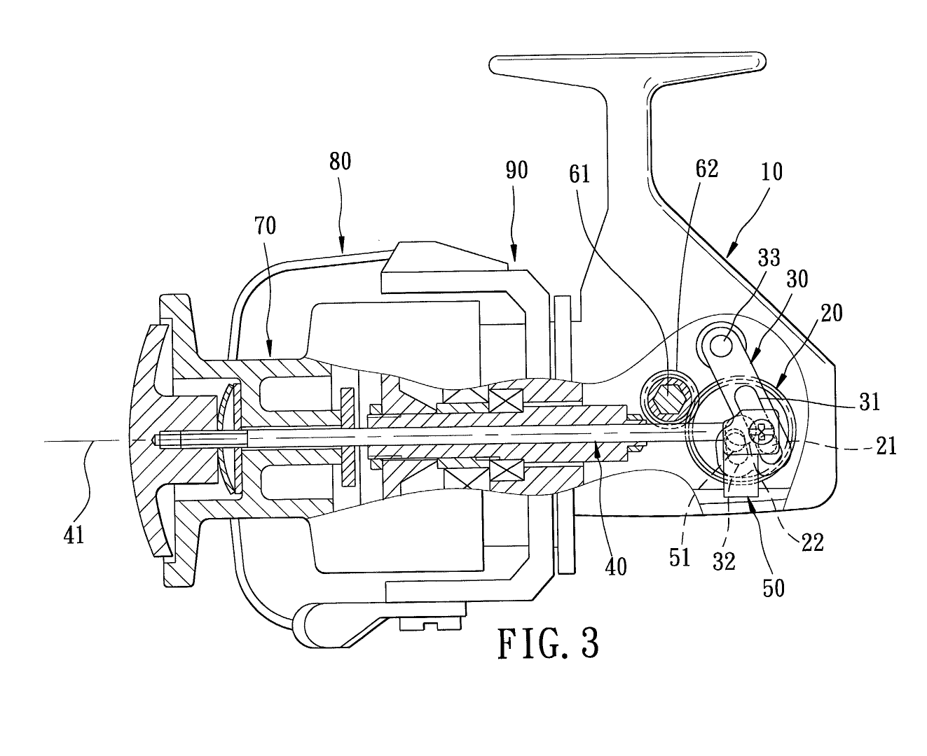

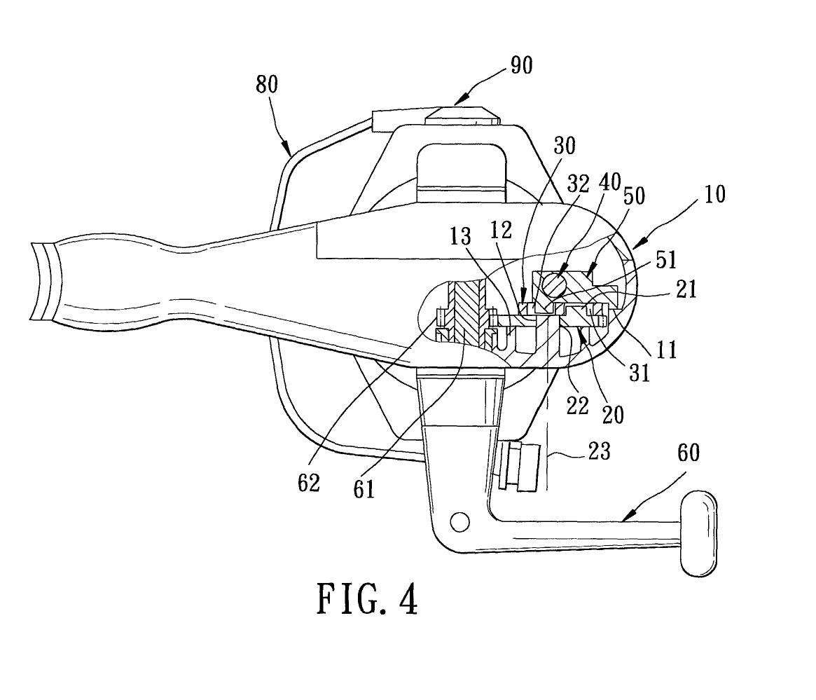

Referring to FIGS. 3 and 4, the preferred embodiment of a spinning type fishing reel according to this invention is shown to include a reel body 10, a rotating member 20, a swing rod 30, a reciprocating shaft 40, a sliding member 50, a handle 60, a spool 70, a bail unit 80, and a rotating unit 90.

The body 10 is hollow, and has an inner surface that is formed with a shoulder 11.

The rotating member 20 is configured as a spur gear, and has an engaging portion 21 and a pivot hole 22. The body 10 is formed with a vertical integral pivot pin 12 that extends through the hole 22. The rotating member 2 is supported on a vertical integral hollow cylinder 13 of the body 10. As such, the rotating member 2 can rotate about a first axis 23. That is to say, the first axis 23 is the rotating axis of the rotating member 2. The engaging portion 21 is configured as a post that is spaced apart from the first axis 23 by a predetermined distance.

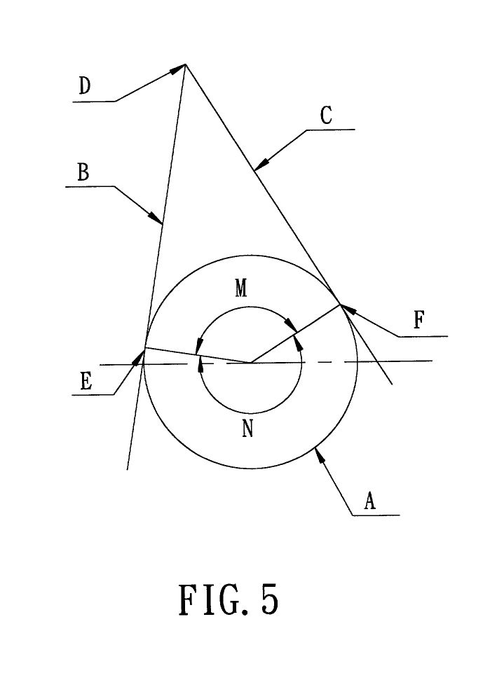

The swing rod 30 has a pair of first and second engaging portions 31, 32, and is connected rotatably to the body 10 by a pivot element 33, which has an axis (D) (see FIG. 5) that is parallel to the first axis 23. The first and second engaging portions 31, 32 are configured as straight slots, which extend in radial directions of the pivot element 33 and which are angularly spaced apart from each other. The engaging portion 21 of the rotating member 20 is received movably within the first engaging portion 31 of the swing rod 30. As such, when the rotating member 20 rotates about the first axis 23, the swing rod 30 swings between two angular positions (B, C) (see FIG. 5) so as to move the engaging portion 21 along a circular path (A) (see FIG. 5). The rotating member 20 is confined between the swing rod 30 and the cylinder 13 of the body 10.

The reciprocating shaft 40 is disposed movably within the body 10 in a known manner, and is movable between two end positions along a second axis 41 that is perpendicular to the first axis 23.

The sliding member 50 is connected fixedly to an end of the reciprocating shaft 40, is movable on the shoulder 11 of the body 10, and has an engaging portion 51 that is configured as a post and that is received movably within the second engaging portion 32 of the swing rod 30 so as to reciprocate the reciprocating shaft 40 when the swing rod 40 swings between the angular positions (B, C) (see FIG. 5).

The handle 60 includes a rotating shaft 61 that is journalled within the body 10, and a gear 62 that is sleeved fixedly on the rotating shaft 61 and that meshes with the rotating member 20 so as to rotate the rotating member 20 about the first axis 23 when the handle 60 is actuated.

The spool 70 is sleeved fixedly on the reciprocating shaft 40 in a known manner.

The bail unit 80 is attached to the rotating unit 90 in a known manner. The rotating unit 90 is disposed rotatably on the body 10 in a known manner. When the handle 60 is actuated, the rotating unit 90 and the bail unit 80 rotate about the second axis 41 so as to wind a fishline around the spool 70.

Referring to FIGS. 3, 4, and 5, when the engaging portion 21 of the rotating member 20 moves to a point (E) of the circular path (A), the swing rod 30 is disposed at the left angular position (B) so that the reciprocating shaft 40 is disposed at the left end position. When the engaging portion 21 of the rotating member 20 moves to a point (F) of the circular path (A), the swing rod 30 is disposed at the right angular position (C) so that the reciprocating shaft 40 is disposed at the right end position. As such, the reciprocating shaft 40 effects a forward travel and a reverse travel during each revolution of the rotating member 20. When the rotating member 20 rotates clockwise by a rotational angle (N) so as to move the engaging portion 21 of the rotating member 20 from the point (F) to the point (E) the reciprocating shaft 40 completes a forward travel. When the rotating member 20 rotates clockwise by a rotational angle (M) so as to move the engaging portion 21 of the rotating member 20 from the point (E) to the point (F), the reciprocating shaft 40 completes a reverse travel. Because the number of the turns of the fishline wound on the spool 70 is proportional to the rotational angle of the rotating member 20, the ratio of the number of the turns of the fishline formed during each forward travel of the reciprocating shaft 40 with respect to that formed during each reverse travel of the reciprocating shaft 40 is N/M. That is to say, the number of the turns of the fishline formed during each forward travel of the reciprocating shaft 40 is different from that formed during each reverse travel of the reciprocating shaft 40, thereby resulting in a quite even distribution of the fishline on the spool 70. When the position of the pivot element 33 is changed, the value of NIM is also changed.

Because the swing rod 30 is disposed between the engaging portion 21 of the rotating member 20 and the engaging portion 51 of the sliding member 50, when the distance between the engaging portion 21 of the rotating member 20 and the first axis 23 is increased by one unit of length, the distance between the end positions of the reciprocating shaft 40 is increased by more than two units of length, the diameter of the circular path (A) being equal to two units of length. Alternatively, the position of the second engaging portion 32 of the swing rod 30 relative to the pivot element 33 can be changed to adjust the distance between the end positions of the reciprocating shaft 40.

With this invention thus explained, it is apparent that numerous modifications and variations can be made without departing from the scope and spirit of this invention. It is therefore intended that this invention be limited only as indicated by the appended claims.

I claim:

1. A spinning type fishing reel comprising:
a reel body;
a rotating member disposed rotatably within said reel body and rotatable about a first axis, said rotating member having an engaging portion;
a swing rod disposed swingably within said reel body and having a first engaging portion that engages said engaging portion of said rotating member so as to swing said swing rod between two angular positions when said rotating member rotates about said first axis, and a second engaging portion;
a reciprocating shaft disposed movably within said reel body and movable within said reel body along a second axis that is perpendicular to said first axis;
a sliding member connected fixedly to said reciprocating shaft and having an engaging portion that engages said second engaging portion of said swing rod so that said reciprocating shaft reciprocates along said second axis when said swing rod swings; and
a handle mounted rotatably on said reel body and rotatable to rotate said rotating member about said first axis.

2. The spinning type fishing reel as claimed in claim 1, wherein said first engaging portion of said swing rod is configured as a slot, said engaging portion of said rotating member being configured as a post that is spaced apart from said first axis by a predetermined distance and that is received movably within said slot in said swing rod.

3. The spinning type fishing reel as claimed in claim 1, further comprising a pivot element for connecting an end of said swing rod rotatably to said body, said first and second engaging portions of said swing rod being configured as straight slots, each of which extends in a radial direction of said pivot element, said straight slots being angularly spaced apart from each other, said engaging portions of said rotating member and said sliding member being configured as posts that are received respectively and movably within said straight slots in said swing rod.
